(19) United States
(12) Patent Application Publication
(10) Pub. No.: US 2013/0201030 A1
(43) Pub. Date: Aug. 8, 2013

(54) RF BASED METER DATA COLLECTION

(71) Applicants: Matthew Johnson, Spokane, WA (US); Roberto Aiello, Bend, OR (US)

(72) Inventors: Matthew Johnson, Spokane, WA (US); Roberto Aiello, Bend, OR (US)

(73) Assignee: ITRON, INC., Liberty Lake, WA (US)

(21) Appl. No.: 13/364,817

(22) Filed: Feb. 2, 2012

(51) Int. Cl. G08C 15/06

(52) U.S. Cl. 340/870.02

(57) ABSTRACT

Disclosed are apparatus and system as well as associated and/or corresponding methodology for exchanging utility consumption data and control information between a consumption measurement device and a utility management system. The presently disclosed subject matter provides for employing a WiFi enable transceiver incorporated as a part of a cable company device such as a set top box. The WiFi transceiver is configured to receive consumption information from a consumer's utility meter (electricity, gas, water) and to transmit the received information to the utility provider by way of the cable company's communications infrastructure. Control signal may also be sent from the utility company to the consumption measurement device by way of the cable company's communications infrastructure.

### FIELD OF THE SUBJECT MATTER

The presently disclosed subject matter relates to metrology and, more specifically, to arrangements for collecting and transmitting utility consumption data from a consumer location to a utility provider location, and corresponding and/or associated devices and systems.

### BACKGROUND OF THE SUBJECT MATTER

Utility companies are constantly looking for lower cost ways of obtaining network connectivity to their meters to acquire timely meter readings and/or to be able to make control or instruction communications. In general, utility data collection has advanced from the earliest days involving meter readers physically going to every consumer location to manually collect consumption information to today's frequently employed data collection methodologies employing such as automatic meter reading (AMR) systems. AMR systems may take on several different forms including such as dial-up systems (where a consumer's telephone line is used) to radio transmission systems (where individual utility meters may automatically connect themselves together in, for example, a mesh network) that automatically collect data from individual meters and conveys the data to a utility central location for processing, billing, and/or other purposes.

Other entities, for example, third party providers such as cable television providers, are also interested in providing energy efficiency, as well as services not necessarily directly associated with delivery of television signals. For example, such entities are developing interests in home automation and security applications that may provide value-added services to their subscribers.

In view of known concerns including economic concerns related to costs associated with utility data collection, it would be advantageous to leverage existing systems to enhance cost savings by combining capabilities of existing and new communications systems to mutual advantage.

While various implementations of metrology data collection systems have been developed, and while various combinations of cooperative communications systems have been developed, no design has emerged that generally encompasses all of the desired characteristics as hereafter presented in accordance with the subject technology.

### SUMMARY OF THE SUBJECT MATTER

In view of recognized features encountered in the prior art and addressed by the presently disclosed subject matter, improved methodologies, system and apparatus have been provided for exchanging utility data between a consumption location and a utility company management system.

In accordance with one presently disclosed exemplary embodiment, the presently disclosed subject matter relates to a method for exchanging utility data between a consumption location and a utility company management system. According to such exemplary method, a consumption measurement device may be enabled for radio frequency (RF) transmission of consumption information while a consumer location proximate RF device may be coupled for transmission of received consumption information to the utility company management system via a third party provider, such as a cable provider, communications infrastructure. In particular embodiments, the RF reception device may be incorporated into an otherwise existing in-home device such as a cable provider set top box. In selected embodiments, the RF transmission may be a WiFi transmission. In some embodiments, the cable provider communications infrastructure may comprise an Internet Service Provider (ISP).

In accordance with still further particular embodiments of present methodology, transmission of received consumption information to the utility company management system may comprise transmission of received electricity, gas, or water consumption information. In certain other exemplary embodiments, transmission of received consumption information to the utility company management system may be conducted through at least one firewall.

In accordance with yet further embodiments, exemplary presently disclosed methodology may provide for coupling the consumer location proximate RF device for transmission of utility company management system information to the consumption measurement device via third party provider (such as cable provider) communications infrastructure.

The presently disclosed subject matter also equally relates to corresponding and/or associated device and/or system subject matter. One presently disclosed exemplary embodiment may relate to a utility data exchange system. In accordance with the presently disclosed subject matter, such exemplary system may comprise a consumption measurement device including a radio frequency (RF) transmitter configured to transmit consumption information, a utility company management system, a cable provider communications infrastructure, and an RF device proximate such consumption measurement device for transmission of received consumption information to the utility company management system via such as cable provider communications infrastructure.

In selected embodiments of the foregoing system subject matter, the RF reception device may comprise an in-home device or cable provider set top box that in some instances may be coupled to a display device, and the in-home device or set top box may be configured to display utility consumption information on the display device. In particular of the subject embodiments, such exemplary display device may comprise a television receiver.

In some presently disclosed embodiments, the RF transmitter may comprise a WiFi transmitter.

In still further particular embodiments of an exemplary presently disclosed system, the cable provider communications infrastructure may comprise an Internet Service Provider (ISP).

In yet certain more particular exemplary embodiments, the system may provide for the transmission of received electricity, gas, or water consumption information. In other particular embodiments, an exemplary system may also provide for transmission of received consumption information to the utility company management system through at least one firewall.

In some particular embodiments, the consumption measurement device may further include a receiver and the RF device may further include a transmitter. Through inclusion of such corresponding receiver and transmitter, the utility company management system may transmit information to the consumption measurement device via such as the cable provider communications infrastructure. In more particular presently disclosed exemplary embodiments, the receiver and transmitter may operate using WiFi technology.

Exemplary embodiments of the presently disclosed subject matter also relate to a third party provider device such as a cable provider device. Such exemplary devices may correspond to a receiver configured to receive radio frequency (RF) transmissions (particularly, for example, a WiFi transmission) from a utility consumption measurement device, and a transmitter configured to transmit information based on received transmissions to a utility management system via the cable provider communications infrastructure.

An exemplary device, in selected embodiments, may include an output port for connection to a display device where the output port is configured to cause the display device to display utility consumption information. In selected exemplary embodiments, the output port may be configured to provide a television compatible output signal. In other embodiments, the output port may be configured to provide a personal computer compatible output signal.

Additional embodiments of the presently disclosed subject matter are set forth in, or will be apparent to, those of ordinary skill in the art from the detailed description herein. Also, it should be further appreciated that modifications and variations to the specifically illustrated, referred and discussed features, elements, and steps hereof may be practiced in various embodiments and uses of the subject matter without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the presently disclosed subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the presently disclosed subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification.

### BRIEF DESCRIPTION OF THE DRAWINGS

A full and enabling disclosure of the presently disclosed subject matter, including the best mode thereof, directed to one of ordinary skill in the art, is set forth in the specification, which makes reference to the appended figure, in which:

FIG. 1 is a schematic block diagram of an overview of an exemplary WiFi enabled data collection system in accordance with the presently disclosed subject matter;

FIGS. 2A and 2B, represent, respectively, exemplary embodiments of a utility meter and a representative third party provider device such as a set top box constructed in accordance with the presently disclosed subject matter; and

FIG. 3 illustrates a flow chart outlining communications methodologies in accordance with the presently disclosed subject matter.

Repeat use of reference characters throughout the present specification and appended drawings is intended to represent same or analogous features, elements, or steps.

### DETAILED DESCRIPTION OF THE SUBJECT MATTER

As discussed in the Summary of the Subject Matter section, the presently disclosed subject matter is particularly concerned with utility data collection and transmission systems, devices, and methodologies.

Selected combinations of aspects of the disclosed technology correspond to a plurality of different embodiments of the presently disclosed subject matter. It should be noted that each of the exemplary embodiments presented and discussed herein should not insinuate limitations of the presently disclosed subject matter. Features or steps illustrated or described as part of one embodiment may be used in combination with aspects of another embodiment to yield yet further embodiments. Additionally, certain features may be interchanged with similar devices or features not expressly mentioned which perform the same or similar function.

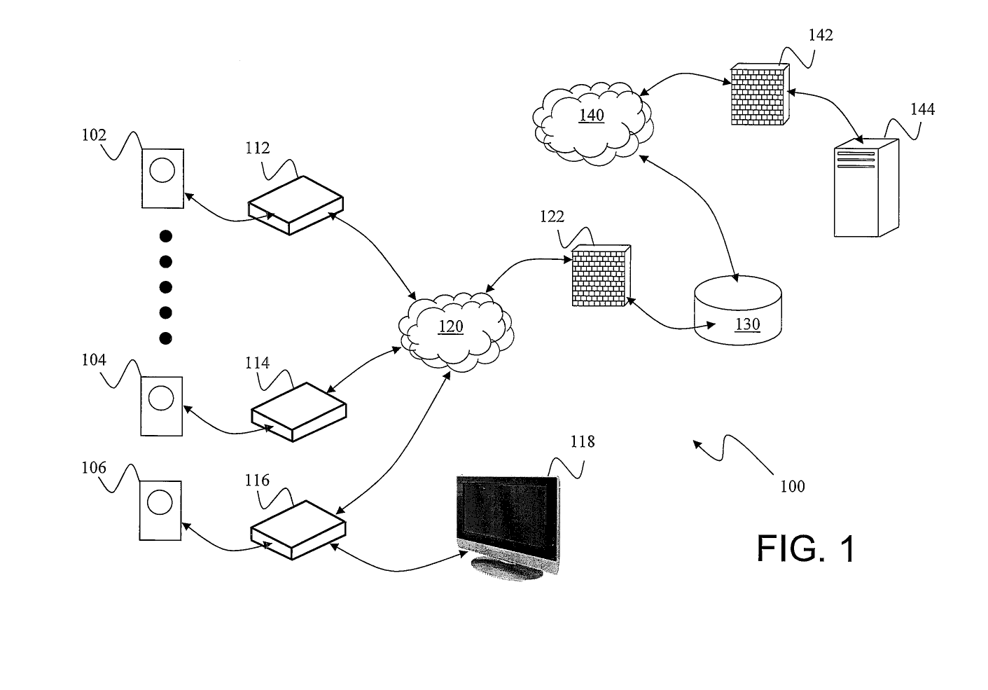

Reference is made in detail to the presently preferred embodiments of the subject utility meter data collection technology, including reference to the drawings, in which FIG. 1 illustrates a schematic block diagram of an overview of a WiFi enabled data collection system generally 100 in accordance with the presently disclosed subject matter.

In accordance with the presently disclosed subject matter, meter reading capability is incorporated for example into devices of a third party provider, such as cable television “set top boxes.” As illustrated in FIG. 1, in WiFi enabled data collection system 100, and representative consumer utility meters 102, 104, 106 installed at various residential and/or commercial locations are provided with WiFi or other RF type transmitters that are designed to transmit consumption data to respective representative set-top boxes 112, 114, 116 by way of receivers installed within or otherwise associated with the set top boxes. Consumer utility meters 102, 104, 106 may correspond to electricity, water, gas or other types of consumption measurements devices or combinations thereof. It should be appreciated that the WiFi devices associated with both the utility meters 102, 104, 106 and set top boxes 112, 114, 116 may correspond to transceivers, that is, devices capable of both transmitting and receiving signals so as to provide bi-directional communications capability between the utility meters and set top boxes.

Still further, those of ordinary skill in the art will appreciate from the broader disclosure herewith that technological alternatives (now or later known or developed) to WiFi communications are also possible and are equally intended to be encompassed by the presently disclosed subject matter. For example, utility meters incorporating so called Encoder-Receiver-Transmitter (ERT) technology (to transmit consumption data to currently utilized utility company receiver/collectors) may be used instead or in combination with, for example, a USB dongle receiver/transmitter to provide a communications link to a set top box.

In addition, it should be understood that while the present exemplary embodiment describes a communications system involving cable technology, such is not a specific limitation of the presently disclosed technology. For example, other technology (now or later known or developed), for example, such as security-related technology, providing at least in part a communications link from a consumer location to a remote utility location, may also be employed to equal advantage and all such communications links are hereinafter also collectively described or referenced as “the cable company,” “a cable network, “a cable system,” or similar language regardless of the particular technology used to provide the actual communications links. Such companies, networks, or systems might include, without limitation, Comcast ®, Charter ®, Cox ®, Time Warner®, ATT's U-verse® system, Verizon's FIOS® system or other companies all hereinafter referred to collectively as cable networks, companies, systems, providers, or similar such terms. DSL service provider systems may also be used and are intended to be identified generally also as a cable provider for present purposes.

Generally speaking, the presently disclosed subject matter will in many embodiments involve employing some type of communications device that may already be in or near a consumer location that has capability to exchange data between devices (including utility meters) and a remote location by way of an existing communications system that is primarily (or at least originally or initially) intended for alternate types of data transmission (for example, entertainment).

Further, those of ordinary skill in the art will appreciate that while the present exemplary configuration provides for a set top box at individual consumer locations, it is within the encompassed subject matter of the presently disclosed technology to provide communications from individual utility meters via a nearby neighbor's set top box or via alternative equipment coupled to the cable company's network and located, for example, on a light pole or similar structure in a neighborhood so as to provide service to individual consumers who may not choose to otherwise subscribe to the cable provider's services.

With continued reference to present FIG. 1, by incorporating (or employing existing) WiFi capability in representative set top box 116, processing hardware within set top box, or, alternatively, added processing hardware, is able to receive utility consumption data from corresponding associated representative meter 106 and to forward such data to a central utility location, representative utility meter data collection and management system generally 144, as will be more fully described later. Along with such data transmission to a central utility location, set top box 116 may also be configured to process and present utility usage information to a local consumer device, such as exemplary representative television receiver 118 as well as to other consumer oriented devices and systems (not separately illustrated) including, without limitation via WiFi to various computing/display devices couple to a home network or via the Internet to a smart phone or other Internet connected device outside of, or remote to, the home (that is, the consumer location associated with representative meter 106).

In the illustrated exemplary embodiment, set top box 116 may also, of course, be configured to display program information transmitted from the cable company on television receiver 118. Representative set top boxes 112, 114 may also have associated therewith (not separately illustrated) television receiving or other communications type equipment, for example, a home computer, that may also be used to view cable programming and/or utility consumption information developed from data obtained from their respective associated representative meters 102, 104. The dots between representative meters 102 and 104 are intended to represent that a plurality of meter arrangements may be contemplated in a given implementation of the present subject matter, as will be well understood by those of ordinary skill in the art. Specifically, stated another way, the presently disclosed subject technology is well suited for scaled-up implementations, which are often associated with the needs of utility providers.

Cable programming may be provided to representative set top boxes 112, 114, 116 by way of the cable company's own network 120 from programming sources (not separately illustrated). As will be understood, such programming sources may include many different sources; however, details regarding such programming and delivery of such programming forms no particular part of the presently disclosed subject matter.

With continued reference to subject FIG. 1, in accordance with the presently disclosed subject matter, data collected from representative meters 102, 104, 106 by way of their respectively associated set top boxes 112, 114, 116 may be transmitted by way of the cable company's network generally 120 through optional firewall 122 to the Internet 130. From there, and based on appropriate addressing supplied by, for example, set top boxes 112, 114, 116, the collected utility data may be transmitted to the utility company's Internet Service Provider (ISP) generally 140, and then through an optional firewall 142 to the utility's meter data collection and management system 144.

Once the set top boxes 112, 114, 116 acquire utility meter readings from electricity, gas, water, or other meters, the information/data can be routed in multiple ways to serve several purposes. In exemplary embodiments, the information can be processed and routed to television 118 to display energy and/or other consumption information to the utility consumer. In addition, the information can be routed to the utility for billing and other purposes and/or sent out over the Internet to the utility customer's mobile devices and/or to any third party designated by the consumer. In addition, in further alternative embodiments of the presently disclosed subject matter, if radio frequency (RF) transceivers are employed, two-way communications can occur between the meters and the set top box, allowing the utility to send commands to the meter, or other technical arrangements may be provided to allow such commands and information to flow to the meter.

With the infrastructure in place to report utility consumption reading through the cable system, other devices for meter readings might be attached to the cable infrastructure, either deriving power from the cable system or from other sources such as available access to power lines, battery power, or solar power or other power sources (now or later known or developed). Such devices might be mounted to such as poles carrying cable system lines or mounted in other convenient locations (either preexisting or otherwise added) to provide additional meter reading capability to the utility or others in locations where a set top box might not be located.

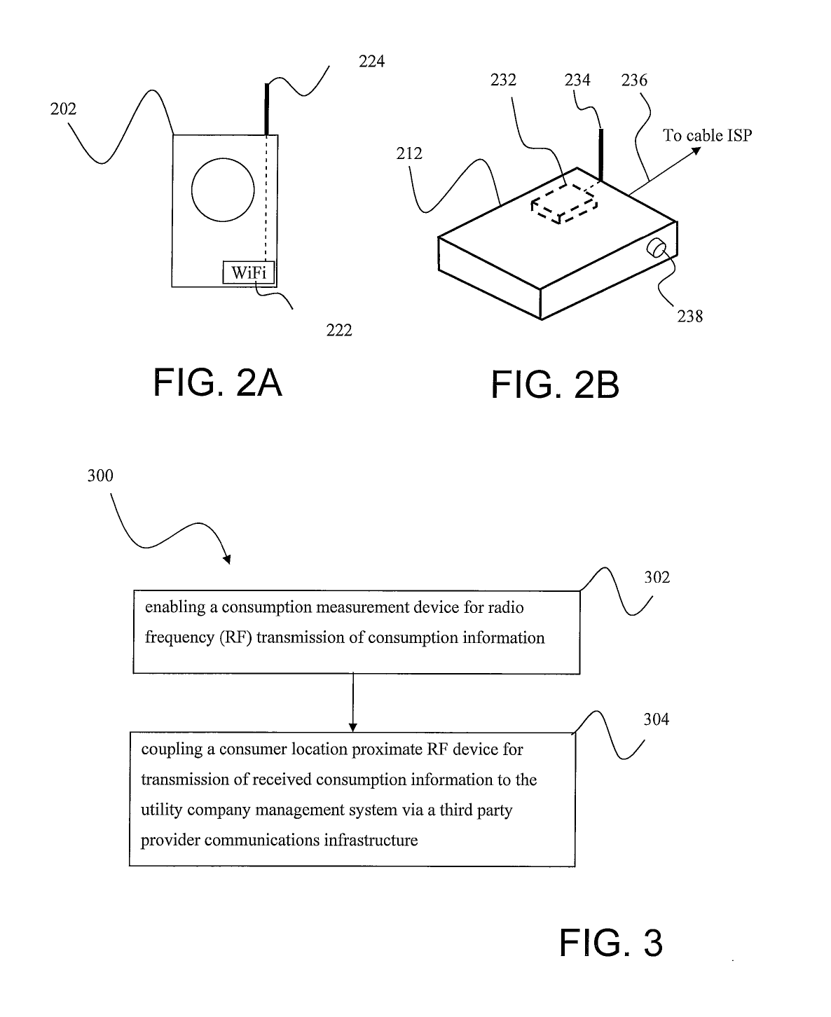

With reference to subject FIGS. 2A and 2B, there are illustrated exemplary embodiments of a representative utility meter 202 (FIG. 2A) and associated representative set top box (FIG. 2B), respectively arranged in accordance with the presently disclosed subject matter. As illustrated in FIG. 2A, utility meter 202 may correspond to, for example, an electricity meter, and may be provided with a WiFi transceiver 222 configured to transmit information (such as measurement data) collected by utility meter 202 to a remote receiver, generally a WiFi receiver associated with a nearby set top box, but possibly also or alternatively to a WiFi receiver mounted at another location but also coupled to the cable system's infrastructure. It is to be understood by those of ordinary skill in the art that other information, not necessarily comprising measurement data, may also be transmitted from time to time, such as tamper data or data regarding required maintenance.

As further illustrated, utility meter 202 may be provided with a representative external antenna 224 coupled to WiFi transceiver 222 for transmission of RF signals. Those of ordinary skill in the art will appreciate that antenna 224 may also be provided as an internal antenna, that is, internal to the enclosure corresponding to the housing for utility meter 202, and may also alternatively comprise a portion of a circuit board otherwise incorporating a WiFi transceiver 222.

As previously mentioned, WiFi receiver 222 may also be configured to receive information from other WiFi enabled transceivers, for example a set top box, and to pass such information to other circuitry (not separately illustrated) associated with utility meter 202. Such additional information may correspond to, for example and without limitation, programming information, instructions to the utility meter including cut off or turn on instructions, or instructions to provide consumption data, or other communications as (and when) desired by the utility company.

With reference to FIG. 2B, there is illustrated an exemplary device 212 with included WiFi transceiver 232 and associated antenna 234 for transmission and reception of RF signals. In one exemplary configuration, device 212 may correspond to a set top box similar to set top boxes 112, 114, 116 of FIG. 1 and may be provided with additional circuitry specifically configured to provide information to, for example, a consumer device such as a television via a representative output or output port 238.

Whenever device 212 is provided as a set top box, additional output ports similar to output port 238 may be provided for connection to other devices including, for example and without limitation, a personal computer, audio/video devices, and HDMI enabled devices.

In one exemplary alternative embodiment, device 212 may correspond to a device configured for mounting on, for example, a line pole providing support for cable infrastructure lines. In either embodiment, device 212 may be coupled via cable 236 to the cable company's ISP for exchange of information between the cable company and one or more WiFi enabled utility meters.

With reference to subject FIG. 3, there is illustrated a flow chart generally 300, representing communications methodologies in accordance with the presently disclosed subject matter. In accordance with the presently disclosed subject matter, one exemplary embodiment of the method calls for, per step 302, enabling a consumption measurement device for radio frequency (RF) transmission of consumption information. In accordance with particular embodiments, such step may involve providing the consumption measurement device with a WiFi enabled transmitter, or possibly a transceiver so that information may be both transmitted and received.

At step 304, the exemplary method also calls for coupling a consumer location proximate RF device for transmission of received consumption information to the utility company management system via a cable provider communications infrastructure. Such consumer location proximate device may, in some embodiments, correspond to providing a set top box at the consumer's location. In particular embodiments, the method provides for transmission of electricity, gas, and/or water consumption information to a utility system and may also include reception of control data or information by the consumption measurement device from the utility.

While the presently disclosed subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the presently disclosed subject matter as would be readily apparent to one of ordinary skill in the art.

What is claimed is:

1. A method for exchanging utility data between a consumption location and a utility company management system, comprising:
enabling a consumption measurement device for radio frequency (RF) transmission of consumption information; and
coupling a consumer location proximate RF device for transmission of received consumption information to the utility company management system via a third party provider communications infrastructure.

2. A method as in claim 1, wherein the third party provider is a cable provider and the RF device comprises a cable provider set top box.

3. A method as in claim 1, wherein the RF transmission comprises a WiFi transmission.

4. A method as in claim 1, wherein the third party provider communications infrastructure comprises an Internet Service Provider (ISP).

5. A method as in claim 1, wherein transmission of received consumption information to the utility company management system comprises transmission of received electricity, gas, or water consumption information.

6. A method as in claim 1, wherein transmission of received consumption information to the utility company management system is conducted through at least one firewall.

7. A method as in claim 1, further comprising coupling the consumer location proximate RF device for transmission of utility company management system information to the consumption measurement device via the third party provider communications infrastructure.

8. A method as in claim 1, further comprising:
coupling the consumer location proximate RF device for transmission of utility company management system information to the consumption measurement device via the third party provider communications infrastructure; and
wherein the third party provider comprises a cable provider, and the RF device comprises a cable provider set top box;
the RF transmission comprises a WiFi transmission; and
transmission of received consumption information to the utility company management system comprises transmission of received electricity, gas, or water consumption information.

9. A utility data exchange system, comprising:
a consumption measurement device including a radio frequency (RF) transmitter configured to transmit consumption information;
a utility company management system;
a third party provider communications infrastructure; and
an RF device proximate said consumption measurement device for transmission of received consumption information to the utility company management system via said third party provider communications infrastructure.

10. A system as in claim 9, wherein the third party provider comprises a cable provider, and the RF device comprises a cable provider set top box.

11. A system as in claim 10, further comprising:
a display device coupled to said set top box; and
wherein said set top box is configured to display utility consumption information on said display device.

12. A system as in claim 11, wherein said display device is a television receiver.

13. A system as in claim 9, wherein the RF transmitter is a WiFi transmitter.

14. A system as in claim 9, wherein the third party provider communications infrastructure comprises an Internet Service Provider (ISP).

15. A system as in claim 9, wherein transmission of received consumption information to the utility company management system comprises transmission of received electricity, gas, or water consumption information.

16. A system as in claim 9, wherein transmission of received consumption information to the utility company management system is conducted through at least one firewall.

17. A system as in claim 9, wherein:
said consumption measurement device further includes a receiver; and
said RF device further includes a transmitter, whereby said utility company management system may transmit information to the consumption measurement device via said third party provider communications infrastructure.

18. A system as in claim 17, wherein said included receiver and said included transmitter communicate using WiFi technology.

19. A cable provider device, comprising:
a receiver configured to receive radio frequency (RF) transmissions from a utility consumption measurement device; and
a transmitter configured to transmit information based on received transmissions to a utility management system via cable provider communications infrastructure.

20. A cable provider device as in claim 19, wherein said receiver is a WiFi enabled receiver.

21. A cable provider device as in claim 19, further comprising:
an output port for connection to a display device; and
wherein said cable provider device is configured to cause the display device to display utility consumption information.

22. A cable provider device as in claim 21, wherein said output port is configured to provide a television compatible output signal.

23. A cable provider device as in claim 21, wherein said output port is configured to provide a personal computer compatible output signal.
